(19) United States
(12) Patent Application Publication
(10) Pub. No.: US 2026/0208429 A1
(43) Pub. Date: Jul. 23, 2026

(54) METHOD FOR CONTROLLING A HEATING STATION

(71) Applicant: SIDEL PARTICIPATIONS, Octeville-sur-Mer (FR)

(72) Inventor: Guy FEUILLOLEY, OCTEVILLE-SUR-MER (FR)

(21) Appl. No.: 19/142,552

(22) PCT Filed: Dec. 13, 2023
(86) PCT No.: PCT/EP2023/085481

§ 371 Date: Jun. 23, 2025

(30) Foreign Application Priority Data
Dec. 26, 2022 (FR) FR2214506

(51) Int. Cl. B29C 49/78; B29C 49/12; B29C 49/64; B29K 67/00; B29L 31/00

(52) U.S. Cl. CPC B29C 49/78; B29C 49/12; B29C 49/6418; B29C 2049/7867; B29C 2049/78755; B29K 2067/003; B29K 2995/002; B29L 2031/7158

(57) ABSTRACT

Provided is a method for controlling a heating station of a facility for manufacturing containers by shaping preforms made of thermoplastic material using heating electromagnetic radiation. The method includes a first step of measuring the absorption spectrum of a wall of a preform in the visible light range upstream of a heating area, and a second step of controlling the power of the heating electromagnetic radiation on the basis of the absorption spectrum measured during the first step, in order to heat the body of the preforms to a set temperature.

### TECHNICAL FIELD OF THE INVENTION

The invention relates to a method for controlling a heating station of a facility for manufacturing containers by shaping, notably by stretch-blowing, preforms made of thermoplastic material, with the preforms being conveyed along a production path that passes through a heating area in which the preforms are exposed to continuous spectrum heating electromagnetic radiation, said spectrum at least partly extending into the visible light range.

### TECHNICAL BACKGROUND

It is known practice for containers to be manufactured by shaping, notably by stretch-blowing, preforms made of thermoplastic material. The material forming the preforms is generally in an amorphous state that is not able to allow the cold shaping thereof. Before the shaping operation, the preforms are therefore heated to a temperature that is greater than or equal to a glass transition temperature that allows them to be shaped as a final container.

More specifically, the preforms generally have a substantially rotationally cylindrical body with a thick tubular wall, one of the axial ends of which is closed by a thick-walled base, and the other end of which is extended by a neck, which is also tubular. The neck is shaped into its final shape and dimensions while the body of the preform is intended to undergo a relatively major deformation in order to shape it into a container during a shaping step.

For this reason, it is preferable for only the body of the preform to be heated to a setpoint temperature that is higher than the glass transition temperature, with the neck remaining at a temperature below said glass transition temperature in order to prevent it from deforming while the container is being manufactured.

Furthermore, the setpoint temperature of the body also should not exceed a crystallization temperature that is greater than the glass transition temperature. Beyond this crystallization temperature, the thermoplastic material crystallizes and no longer has the mechanical properties for shaping to the required quality.

The mass production of containers is carried out in a production facility in which the preforms run along a pre-determined production path. Each preform is supported by conveying means. Such conveying means can be formed by a rail conveyor, along which the preforms are free to come into contact with each other, or a conveyor that has components for gripping each preform individually.

The production facility has a heating station that allows, during a heating step, the body of the preform to be rendered malleable by heating beyond the setpoint temperature. During the heating step, each preform is exposed to heating radiation during its movement. The power of the heating radiation is controlled so as to allow the body of the preforms to be heated to the setpoint temperature.

The production facility also comprises a shaping station that is arranged downstream of the heating station in the direction of flow of the preforms in the production facility. During the shaping step, the hot preform is placed in a shaping unit, for example, in a mold of the shaping station that has a molding imprint matching the container to be obtained. A pressurized fluid, such as air, is then injected into the malleable body of the preform in order to press the wall against the imprint of the mold. Generally, the injection of pressurized fluid is preceded and/or accompanied by axial stretching of the preform, notably by means of a stretching rod inserted into the preform. In a known manner, the body thus undergoes bi-axial stretching.

When passing through the heating station, each preform is generally exposed to continuous spectrum heating radiation that allows the thermoplastic material to be heated. The temperature at which the preforms are heated generally depends on the absorption factor (A) of the preform for the wavelengths of the heating radiation. The absorption factor (A) is sometimes referred to as “absorptance”.

The absorption factor (A) is defined as being the ratio of the flux of absorbed heating radiation to the flux of incident heating radiation. The flux of absorbed heating radiation causes the temperature of the thermoplastic material forming the preform to increase. The absorption factor (A) of the preform thus allows the increase in temperature of a preform to be known as a function of the intensity of the infrared radiation and of the duration of exposure to said radiation. Less energy is required to heat a preform with a high absorption factor (A) compared to a preform with a lower absorption factor (A).

The absorption factor (A) can be derived from two other parameters, called the transmittance (T) of the preform, as well as its reflectance (R).

The transmittance (T) is defined as the ratio of the flux of heating radiation transmitted through at least one wall of the preform to the flux of incident heating radiation.

The reflectance (R) is defined as the ratio of the flux of heating radiation reflected by the preform to the flux of incident heating radiation. The reflectance (R) is computed, for example, as a function of the refractive index (n) of the thermoplastic material according to the following formula:

$$R = {[ ( n - 1 ) / ( n + 1 ) ]}^{2}$$

in which the value of “1” corresponds to the refractive index of air.

These three factors depend on the wavelength of the considered radiation.

The heating radiation at least partly extends into the near infrared band, as it is known that thermoplastic materials, such as PET, absorb this type of radiation very easily. The wavelength that is considered for defining the transmittance of the preform is therefore generally taken in the near infrared band.

These three factors are related to each other by the following equation:

$$R = {[ ( n - 1 ) / ( n + 1 ) ]}^{2}$$

The transmittance depends on the wavelength of the radiation passing therethrough.

Thus, a perfectly transparent preform has transmittance close to 100% for wavelengths in the visible light range, while it has significantly lower transmittance for radiation with a wavelength in the near infrared band. This reflects the fact that the preform can be heated by radiation belonging to the near infrared band, while radiation in the visible light range will only have a negligible influence on the temperature of the preform, even at high powers.

Sometimes the preforms are made of a material with a tint.

This tint can be intentionally obtained by adding dye in order to dye the preform to a desired color in order to obtain a colored container.

This tint also can be applied unintentionally and uncontrollably, for example, when the preform is made of a plastic material at least partly made up of recycled plastic material. This is the case, for example, when the preform is made of recycled polyethylene terephthalate (rPET). In this case, the preform has a fairly dark tint depending on the quality and the amount of recycled material incorporated into the composition of its constituent thermoplastic material.

The inventor has found that, in both cases, the tint of the plastic material is likely to influence the temperature of the wall of the preform when it is exposed to heating radiation.

Indeed, the heating radiation has a spectrum that at least partly extends into the visible light range. However, when the preform has a tint, and notably a dark tint, this portion of the spectrum of the heating radiation is likely to significantly heat the thermoplastic material.

### SUMMARY OF THE INVENTION

The invention proposes a method for controlling a heating station of a facility for manufacturing containers by shaping, notably by stretch-blowing, preforms made of thermoplastic material, the preforms being conveyed along a production path that passes through a heating area in which the preforms are exposed to continuous spectrum heating electromagnetic radiation, said spectrum at least partly extending into the visible light range,

characterized in that the method comprises:
a first step of measuring the absorption spectrum of a wall of a preform in the visible light range in a measurement area traversed by the production path upstream of the heating area;
a second step of controlling the power of the heating electromagnetic radiation as a function of the absorption spectrum measured during the first step for heating the body of the preforms to a setpoint temperature.

According to another feature of the method carried out according to the teaching of the invention, the second control step comprises a first sub-step of computing a corrected power of the heating electromagnetic radiation as a function of the absorption spectrum measured during the first step, and a second sub-step of controlling the power of the heating electromagnetic radiation at said corrected power computed during the first sub-step.

According to another feature of the method carried out according to the teaching of the invention, during the first computation sub-step, the measured absorption spectrum is used to compute the parameters of the wall of the preform in a determined color space equivalent to the CIELAB color space as defined by ISO standard 11664-4:2019.

According to another feature of the method carried out according to the teaching of the invention, the corrected power is computed during the first sub-step at least as a function of the value of a parameter representing the luminance of the wall in the determined color space.

According to another feature of the method carried out according to the teaching of the invention, the corrected power is computed as a function of a rate of said parameter that is computed according to the following equation:

$$A = 1 - R - T$$

where p₀ represents a reference value of the parameter and p represents the parameter computed based on the absorption spectrum measured during the first step.

According to another feature of the method carried out according to the teaching of the invention, the corrected power is computed as a function of the proportion of the power of the heating electromagnetic radiation extending into the visible light range.

According to another feature of the method carried out according to the teaching of the invention, the heating radiation at least partly extends into the near infrared band and it comprises a fourth step of measuring an infrared transmittance of a wall of said preform for at least one wavelength belonging to the near infrared band, with this fourth step being carried out prior to the first computation sub-step.

According to another feature of the method carried out according to the teaching of the invention, the corrected power is computed as a function of a transmission rate that is computed according to the following equation:

$$Δ T ( λ 2 ) = \frac{{T}_{0} ( λ 2 ) - T ( λ 2 )}{{T}_{0} ( λ 2 )}$$

where T0(λ2) represents a reference infrared transmittance value and T(λ2) represents the infrared transmittance measured during the fourth step.

According to another feature of the method carried out according to the teaching of the invention, the corrected power is computed as a function of the proportion of the power of the heating electromagnetic radiation extending into the near infrared band.

The invention also relates to a facility for implementing the method, the facility comprising means for conveying preforms in a line along a predetermined production path successively passing through an area for heating a body of the preforms and through a station for shaping the preforms into a container, notably by stretch-blowing, characterized in that the facility comprises a device for measuring the absorption spectrum in the visible light range of at least one wall of the preforms when they pass through an associated measurement area.

According to another feature of the facility produced according to the teaching of the invention, the device for measuring the absorption spectrum comprises:
a first light source that emits a first light beam according to a continuous spectrum that at least extends into the visible range;
a spectrometer measuring the intensity and the wavelength of the first light beam after passing through at least one thickness of the wall of the preform.

According to another feature of the facility produced according to the teaching of the invention, it comprises a device for measuring the infrared transmittance of at least one wall of the preforms when they pass through an associated measurement area.

According to another feature of the facility produced according to the teaching of the invention, the device for measuring a value representing the infrared transmittance comprises:
a light source that emits a light beam having at least one second wavelength in the near infrared band;
a measurement component measuring the intensity for the at least one second wavelength of said light beam after passing through at least one thickness of the wall of the preform.

According to another feature of the facility produced according to the teaching of the invention, the first light beam emitted by the first light source has a continuous spectrum that comprises said at least one second wavelength.

According to another feature of the facility produced according to the teaching of the invention, the device for measuring a value representing the infrared transmittance comprises a second light source that is distinct from the first light source and that emits a second light beam having at least one second wavelength in the near infrared band.

According to another feature of the facility produced according to the teaching of the invention, the first light beam and the second light beam pass through the wall of the preform at the same height.

According to another feature of the facility produced according to the teaching of the invention, the first light beam and the second light beam are merged into a common beam before reaching the preform.

According to another feature of the facility produced according to the teaching of the invention, the measurement of the infrared transmittance and the measurement of the absorption spectrum are carried out simultaneously in the same measurement area of the production path.

According to another feature of the facility produced according to the teaching of the invention, the measurement component of the device for measuring the infrared transmittance and the spectrometer of the device for measuring the absorption spectrum are formed by a single spectrometer common to the two devices.

### BRIEF DESCRIPTION OF THE FIGURES

Further features and advantages of the invention will become apparent while reading the following detailed description, which is to be understood with reference to the appended drawings, which are briefly described hereafter.

FIG. 1 is a top view schematically showing a facility for manufacturing containers produced according to the invention comprising a heating station.

FIG. 2 is a side view that shows a preform to be processed by the facility of FIG. 1.

FIG. 3 is a vertical cross-sectional view along the sectional plane 3-3 of FIG. 1 that shows a device for measuring an absorption spectrum in the visible light range of the walls of a preform circulating in the facility produced according to a first embodiment.

FIG. 4 is a block diagram that shows a method for implementing the facility of FIG. 1 for controlling the heating station according to a first embodiment of the invention.

FIG. 5 is a diagram indicating light intensity values on the ordinate and wavelength values on the abscissa that uses dashed lines to show the spectrum of a first light beam emitted by a light source of the device of FIG. 3 and that uses a solid line to show the absorption spectrum of the wall of the preform.

FIG. 6 is a block diagram similar to that of FIG. 4 that shows a method for implementing the facility of FIG. 1 for controlling the heating station according to a second embodiment of the invention.

FIG. 7 is a vertical cross-sectional view along the sectional plane 3-3 of FIG. 1 that shows a device for measuring an absorption spectrum in the visible light range combined with a device for measuring the infrared transmittance of the walls of a preform circulating in the facility produced according to a second embodiment.

FIG. 8 is a diagram similar to that of FIG. 5 that uses dashed lines to show the spectrum of a light beam emitted by two light sources of the device of FIG. 7 and that uses a solid line to show the absorption spectrum of the wall of the preform, as well as the transmitted beam in the near infrared band.

### DETAILED DESCRIPTION OF THE INVENTION

Throughout the remainder of the description, the terms “top”, “bottom”, and the derivative terms “high”, “low”, are used for the sake of clarity with reference to the orientation of the figures, yet without this having any limiting scope.

Throughout the remainder of the description, the wavelengths of the light radiation will be expressed in nanometers, indicated by the abbreviation “nm”.

In theory, a monochromatic source is an ideal source emitting a single frequency sine wave. In other words, its frequency spectrum is made up of a single line with a zero spectral width (Dirac).

In practice, such a source does not exist, an actual source with a frequency emission spectrum that extends over a band with a low but non-zero spectral width, for example, a few tens of nanometers, is centered on a main frequency where the intensity of the radiation is maximum.

Throughout the remainder of the description, such an actual source is considered to be monochromatic.

Hereafter, an absorption spectrum is defined as being a curve that represents the value of the intensity of a continuous spectrum light beam as a function of the wavelength after it passes through a medium to be analyzed, notably the wall of a preform.

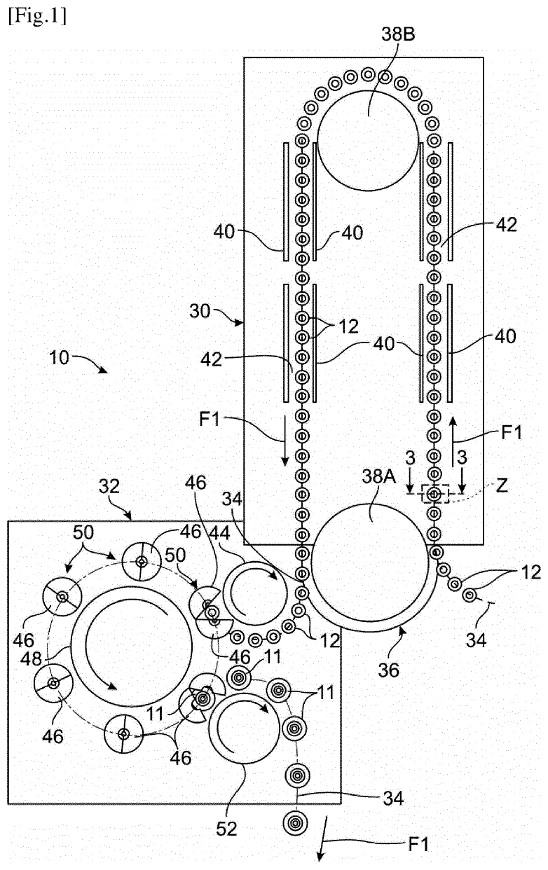

FIG. 1 schematically illustrates a facility 10 for manufacturing containers 11 from preforms 12 made of thermoplastic material and more specifically made of PET (polyethylene terephthalate) or rPET (recycled polyethylene terephthalate). The thermoplastic material can optionally, but not necessarily, contain additives that artificially increase the absorption factor of the preform, or even a dye for changing the color.

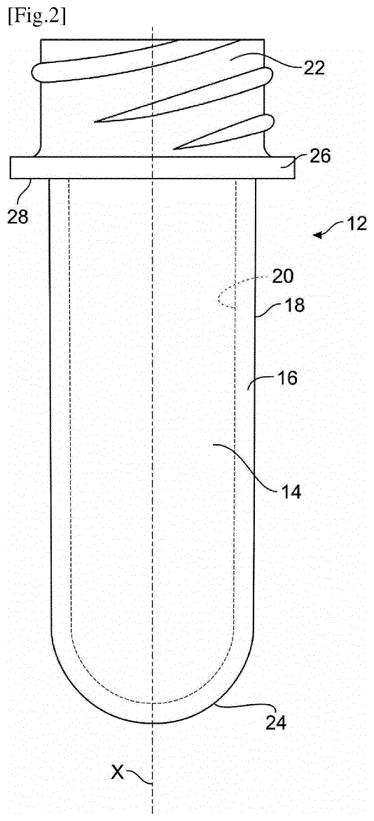

As shown in FIG. 2, each preform 12 comprises a cylindrical body 14 with an “X” axis. The body 14 comprises a transparent side wall 16 that defines an internal volume. The wall 16 has a rotational shape about the “X” axis so that at a given height, the wall 16 has a constant thickness. However, the thickness of the wall 16 is likely to vary as a function of the height. The wall 16 is delimited by an outer face 18 that is oriented toward the outside of the preform 12 and by an inner face 20 that faces the internal volume.

An upper end of the body 14 emerges through a neck 22. The neck 22 assumes the definitive shape of that of the container 11 to be obtained. As a result, the neck 22 does not experience any deformation while the container 11 is being manufactured. The body 14 comprises a base 24 that closes its lower end and that is generally hemispherical. The neck 22 comprises a collar 26 arranged at its junction with the body 14. The lower face of the collar 26 is intended to form a bearing surface 28 for supporting the preform 12 while it is molded and/or conveyed.

After being injection molded, the preforms 12 are suddenly cooled so that an amorphous state is imparted to the thermoplastic material. It is thus possible to make the thermoplastic material malleable once again by heating beyond a glass transition temperature.

With further reference to FIG. 1, the manufacturing facility 10 comprises a heating station 30 and a shaping station 32. The preforms 12 move in a line along a production path 34 that passes through the heating station 30 and the shaping station 32. The direction of travel of the preforms 12 is indicated by the arrows “F1” in FIG. 1. During normal operation of the manufacturing facility 10, the preforms 12 constantly move along the production path 34.

The purpose of the heating station 30 is to heat the body 14 of the preforms 12 to a setpoint temperature that is greater than or equal to the glass transition temperature of the constituent material, for example, greater than 70° C. when this material is PET or rPET. The heating station 30 comprises a conveyor 36 (schematically illustrated) for conveying the preforms 12 by rotating them on themselves.

The conveyor 36 generally comprises mandrels (not shown) that fit together with the neck 22 in order to convey the preforms 12. The mandrels move along a closed circuit. The mandrels are, for example, supported by the links of a chain or even by independent shuttles moving along a rail.

In this case, the circuit comprises two straight parallel sections connected by sections with 180° turns. The conveyor 36 further comprises two wheels 38A, 38B for guiding the mandrels in the turning portions of the closed circuit.

The heating station 30 also comprises heating means 40 for heating the preforms 12. This involves, for example, lamps facing reflectors that emit continuous spectrum heating electromagnetic radiation.

The heating radiation at least partly extends into the near infrared band that is within a wavelength range that ranges between 780 nm and 3,000 nm.

The intensity of the heating electromagnetic radiation is notably higher in a higher intensity wavelength range that ranges between 800 nm and 1,600 nm.

The heating radiation also at least partly extends into the visible light range that generally ranges between 380 nm and 780 nm.

The spectrum of the heating radiation extends, for example, between 300 nm and 3,000 nm.

The heating means 40 are arranged along a heating area 42 of the production path 34 of the preforms. In the example shown in FIG. 1, the heating station 30 comprises a heating area 42 divided into two parts arranged upstream and downstream of the turning portion guided by the guide wheel 38B.

The preforms 12 entering the heating station 30 are individually supported by the conveyor 36 on which they follow a U-shaped section on their production path 34 passing through the heating area 42. They are heated throughout the production run by the heating means 40, which, if necessary, are placed on one side or on either side of the preforms 12 with respect to their direction of travel. The hot preforms 12 are extracted from the heating station 30 after they pass through the heating area 42 and are transferred into molds on the shaping station 32 by a first transfer device 44, such as a transfer wheel, interposed between the heating station 30 and the shaping station 32.

The transfer wheel comprises arms (not shown, as they are known per se) that successively grip the preforms 12, as they leave the heating station 30, in the vicinity of their neck 22, so that they are each in turn introduced into a mold 46 of the shaping station 32. The shaping station 32 comprises a rotating carousel 48, with a plurality of blowing stations 50 being disposed on the periphery of said carousel.

Each blowing station 50 comprises at least one mold 46 that defines a cavity with the imprint of the container 11. Each blowing station 50 comprises means (not shown) for forming/deforming the body 14 of the preform 12 and pressing it against the imprint of the mold 46, for example, by stretch-blowing.

Each hot preform 12 exiting the heating station 30 is introduced into a mold 46 of the blowing station 50 to be blown therein and transformed into a container 11. Once completed, the container 11 is extracted from the blowing station 50 by a second transfer device 52 similar to the first transfer device 44.

Generally, the heating means 40 emit the heating radiation at a power that is only determined as a function of the absorption factor of the preforms 12 in the near infrared band in order to reach the setpoint temperature. This power is computed by considering that the preform 12 has perfectly transparent walls 16 in the visible light range.

In order to allow the preforms 12 to be heated as closely as possible to the setpoint temperature, the invention proposes a method for controlling the heating station 30 that involves measuring an absorption spectrum “σ(λ1)” of the wall 16 of the preform 12 in the visible light range in a measurement area “Z” traversed by the production path 34 upstream of the heating area 42, and then involves controlling the power of the heating electromagnetic radiation as a function of the measured absorption spectrum “σ(λ1)”.

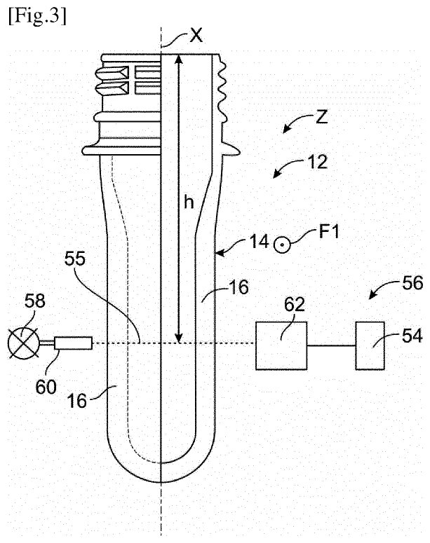

This method is automatically implemented in this case by an electronic control unit 54, notably shown in FIG. 3. This method is implemented when the preform 12 is conveyed by a conveyor along the production path 34 in the facility 10 for manufacturing containers 11. Preferably, the preform 12 is constantly moving when implementing the method.

In the examples shown in the figures, the method is implemented when the preforms 12 are conveyed by the conveyor 36 of the heating station 30. This conveyor 36 conveys the preforms 12 through the heating area 42.

The method is preferably implemented on the preforms 12 before they are heated, therefore upstream of the heating area 42.

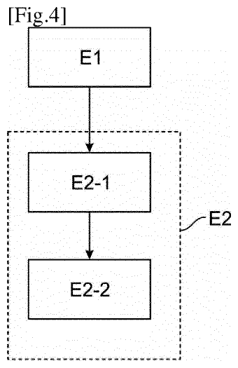

As shown in FIG. 4, the method thus comprises a first step “E1” of measuring the absorption spectrum “σ(λ1)” of the wall 16 of a preform 12 in the visible light range.

The first step “E1” of measuring the absorption spectrum “σ(λ1)” in this case is carried out by measuring the attenuation of the intensity “I” of a first light beam 55 with a continuous spectrum “σ0” in the visible range for each wavelength of the spectrum “σ0”.

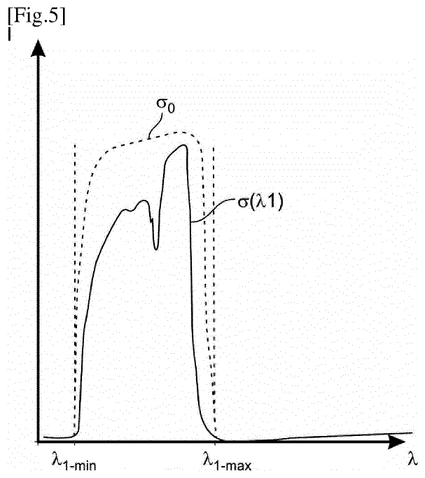

The first light beam 55 is a light beam, called “white” light beam, that emits in the visible light range, i.e., generally between 380 nm and 780 nm. For example, the spectrum “σ0” of the first light beam 55 extends in a wavelength range “λ1” that extends between a lower limit “λ1-min”, for example, equal to 400 nm, and an upper limit “λ1-max”, for example, equal to 700 nm. The spectrum “σ0” of the first light beam 55 is shown by a dashed curve in FIG. 5.

To this end, the facility 10 comprises a device 56 for measuring the absorption spectrum “σ(λ1)” in the visible light range. As shown in FIG. 5 using a solid line curve, this device 56 is arranged to measure the absorption spectrum “σ(λ1)” of a preform 12 passing through the measurement area “Z” shown in FIG. 1.

As shown in FIG. 3, the device 56 for measuring the absorption spectrum “σ(λ1)” in the visible light range comprises a first light source 58 that emits the first continuous spectrum “σ0” light beam 55.

The first light source 58 comprises, for example, a light emitting diode (LED), a superluminescent diode (SLED) or a lamp. The first light beam 55 is emitted perpendicular to the wall 16 of the preform 12. The first light beam 55 is emitted so as to pass through the preform 12 by passing through its main “X” axis.

The first light beam 55 is more specifically emitted along an axis that is perpendicular to a tangent to the production path 34 of the preform 12 in the measurement area “Z”.

The first light beam 55 passes through the wall 16 at a determined height “h”.

The first light beam 55 can be guided in the correct direction by an optical guide means such as an optical fiber 60.

The device 56 for measuring the absorption spectrum “σ(λ1)” in the visible light range further comprises a spectrometer 62 that measures the intensity “I” as a function of the wavelength “λ1” of the spectrum “σ0” of the first light beam 55 after it has passed through the wall 16 of the body 14 of the preform 12 at least once, as shown in FIG. 5.

The spectrometer 62 in this case is arranged so as to measure the intensity “I” of the first light beam 55 on the other side of the preform 12 with respect to the “X” axis of the preform 12 after it has passed through the wall 16 twice at two diametrically opposite points, at the same height “h” on the preform 12.

In a variant of the invention, not shown, the spectrometer is arranged so as to measure the intensity of the first light beam after it has passed through the wall of the preform once. In this case, a component for intercepting the light beam is introduced into the preform during the first step, with the interception component guiding the intercepted light beam to the spectrometer.

The spectrometer 62 thus allows the measured absorption spectrum “σ(λ1)” shown in FIG. 5 to be obtained.

As shown in FIG. 4, the method further comprises a second step “E2” of controlling the power of heating electromagnetic radiation as a function of the absorption spectrum “σ(λ1)” measured during the first step “E1”. This second control step “E2” is implemented by the electronic control unit 54 that receives the data measured by the spectrometer 62.

The second control step “E2” comprises a first sub-step “E2-1” of computing a corrected power “Ptc” of the heating electromagnetic radiation as a function of the absorption spectrum “σ(λ1)” measured during the first step “E1”. This corrected power “Ptc” corresponds to the power actually required to heat the preform 12 to the setpoint temperature by taking into account the influence of the tint of the preform 12.

During this first computation sub-step “E2-1”, the measured absorption spectrum “σ(λ1)” is used to compute the parameters of the color of the wall 16 of the preform 12 in a determined color space.

By way of a non-limiting example, such a color space in this case is formed by the CIELAB color space, as defined by ISO standard 11664-4:2019, sometimes referred to as “CIE 1976 L*a*b*”.

As a variant of the invention, not shown, the determined color space can be another normalized color space equivalent to the CIELAB space, such as the CIE RGB color space, defined by ISO standard 61966-2-1:2003, or the CIE XYZ color space, defined by standard 11664-3:2019, or the CIE 1976 L*u*v* color space, defined by ISO standard 1164-5:201 6, or even the CIE U′V′W color space. A color space is “equivalent” to the CIELAB space when a bijection exists for easily transitioning from one space to another.

Three parameters characterize the colors in the CIELAB color space. The lightness L* is derived from the luminance. The two parameters a* and b* express the deviation of the color from that of a gray surface with the same lightness. A gray, uncolored, achromatic surface is illuminated by a reference light that in this case is determined to be D65 normalized daylight according to ISO standard 23603:2005.

The system parameters L*a*b* are thus:
the lightness L*, which assumes values between 0, corresponding to black, and 100, corresponding to white;
a* represents the value on an axis ranging from green to red;
b* represents the value on an axis ranging from blue to yellow.

According to ISO standard 11664-4:201 9, the various parameters are computed as a function of the transmittance T(λ1) for each associated wavelength.

More specifically, the emission light intensity “I0” at which the first light beam 55 is emitted as a function of the wavelength “λ1” is known data. The light intensity “I0” at which the first light beam 55 is emitted also can be measured directly by the spectrometer 62 when no preform 12 passes through the measurement area “Z1”, as shown by the dashed line curve in FIG. 5.

After passing through the wall 16 of the preform 12 twice, the light intensity of the first light beam 55 is attenuated. The first light beam 55 then has a light intensity, called “transmitted light intensity “I1”, as shown by the solid line curve in FIG. 5.

Thus, it is easy to derive the transmittance of the wall 16 of the preform therefrom as a function of the wavelength in the visible light range by determining the ratio of the emission light intensity “I0” to the transmitted light intensity “I1”.

Each parameter in the determined color space, such as the CIELAB space, is then computed as a function of the transmittance T(λ1) and of the associated wavelength “λ1”.

The corrected power “Ptc” is computed during the first sub-step at least as a function of at least one parameter of the determined color space, such as a parameter representing the luminance of the wall 16. The corrected power “Ptc” is more specifically computed as a function of a rate of said parameter “Δ” that is computed according to the following equation:

$$Δ p = \frac{{p}_{0} - p}{{p}_{0}}$$

where p₀ represents a reference value of the parameter and p represents the parameter computed based on the absorption spectrum “σ(λ1)” measured during the first step “E1”.

According to one embodiment, the corrected power “Ptc” is computed during the first sub-step at least as a function of the lightness parameter “L*” of the CIELAB color space. The corrected power “Ptc” is more specifically computed as a function of a lightness rate “ΔL*” that is computed according to the following equation:

$$Δ {L}^{*} = \frac{{L}_{0}^{*} - {L}^{*}}{{L}_{0}^{*}}$$

where L₀* represents a reference lightness value and L* represents the lightness computed based on the absorption spectrum “σ(λ1)” measured during the first step “E1”.

The reference value is, for example, the value of the parameter, in this case the lightness, that corresponds to the specifications of a preform 12, called reference preform 12. It also can be said parameter, in this case the lightness, of a preform 12 taken as a sample from the batch of preforms 12 to be processed by the facility 10, or even the average of the values of said parameter, in this case the lightness, of a sample of several preforms 12 taken from the batch of preforms 12 to be processed.

The rate of said parameter “Δp”, for example, the lightness rate “ΔL*”, is thus likely to vary between 0, for a preform 12 with the same value as the reference preform 12, and 1.

The corrected power “Ptc” is also computed as a function of the proportion of the power of the heating electromagnetic radiation extending into the visible light range. Indeed, the heating electromagnetic radiation in this case extends in the visible light range and, for the majority, into the near infrared band.

Thus, the total power of the heating electromagnetic radiation thus can be expressed as follows:

$$Pt 0 = Pnir 0 + Pvis 0$$

where Pt0 represents the instantaneous total power of the heating electromagnetic radiation for heating the reference preform 12 to the setpoint temperature, PnirO represents the instantaneous power of the heating electromagnetic radiation emitted in the near infrared band, and PvisO represents the instantaneous power of the heating electromagnetic radiation emitted in the visible light range.

The corrected power “Ptc” of the heating electromagnetic radiation is then computed according to the following equation:

$$Ptc = Pnir 0 + Pvis 0. ( 1 - Δ p )$$

When using the lightness rate “ΔL*” to compute the corrected power “Ptc” of the heating electromagnetic radiation, the equation becomes:

$$Ptc = Pnir 0 + Pvis 0. ( 1 - Δ L \text{*)}$$

Preferably, but not necessarily, to prevent the power of the heating radiation from changing too chaotically and quickly as a function of the various values measured for each preform 12, the corrected power “Ptc” is computed by taking into account the measurement of said parameter, notably the lightness, for several successive preforms 12.

The number of preforms 12 is, for example, equal to the number of preforms likely to be simultaneously contained in the heating area 42. In this case, it is a sliding average that is updated for each new preform 12 received in the measurement area “Z”.

During a second control sub-step “E2-2” of the second step “E2”, the power of the heating electromagnetic radiation is controlled as a function of the correction value computed during the first sub-step “E2-1” of heating the body 14 of the preforms 12 to the setpoint temperature by taking into account the tint of the preforms 12.

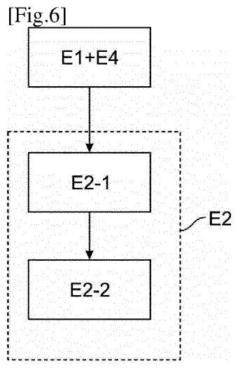

According to a second embodiment of the invention shown in FIG. 6, in order to best control the power of the heating radiation, the method described above further comprises a fourth step “E4” of measuring an infrared transmittance “T(λ2)” of the wall 16 of said preform 12 for at least one wavelength “λ2” belonging to the near infrared band. This notably allows the variation to be considered for the infrared transmittance “T(λ2)” of the preforms 12 from the same batch of preforms 12 to be processed in the second step “E2” of the method and notably in the first sub-step “E2-1” of computing the corrected power “Ptc”.

This fourth step “E2” is carried out prior to the first computation sub-step “E2-1”. It can be carried out before, after or during the first measurement step “E1”.

The fourth step “E4” of measuring the infrared transmittance “T(λ2)” in this case is carried out by measuring the attenuation of the intensity “I” of a second light beam 66 that includes a second predetermined wavelength “λ2”. The second predetermined wavelength “λ2” is included in the near infrared band. It preferably belongs to the higher intensity wavelength range of the heating electromagnetic radiation, in this case ranging between 800 nm and 1,600 nm.

It also can involve a wavelength range belonging to the near infrared bands, for each of which the transmittance is measured.

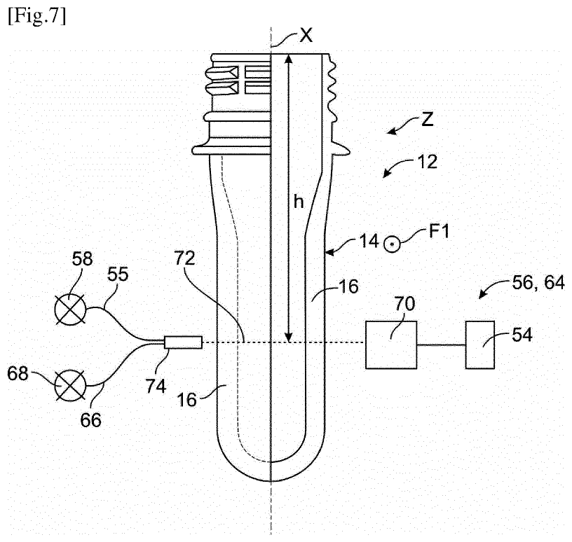

To this end, the facility 10 comprises a device 64 for measuring the infrared transmittance “T(λ2)” shown in FIG. 7. As shown in FIG. 1, this device 64 is arranged to measure the infrared transmittance “T(λ2)” of a preform 12 passing through said measurement area “Z”.

The device 64 for measuring the infrared transmittance “T(λ2)” comprises a second light source 68 that emits the second light beam 66 with the second wavelength “λ2”. It can be a monochromatic light source, but this is not compulsory.

The second light source 68 comprises, for example, a light emitting diode (LED), a superluminescent diode (SLED) or a lamp. The second light beam 66 is emitted perpendicular to the wall 16 of the preform 12. The second light beam 66 is emitted so as to pass through the preform 12 by passing through its main “X” axis. The second light beam 66 passes through the wall 16 at said height “h”. Thus, the first light beam 55 and the second light beam 66 pass through the wall 16 of the preform 12 at the same height “h”.

The second light beam 66 is more specifically emitted along an axis that is perpendicular to a tangent to the production path 34 of the preform 12 in the measurement area “Z”.

The second light beam 66 can be guided in the correct direction by an optical guidance means such as an optical fiber.

The device 64 for measuring the infrared transmittance “T(λ2)” further comprises a component for measuring the intensity “I” of the second light beam 66 after passing through the wall 16 of the body 14 of the preform 12 at least once.

The intensity “I” measurement component in this case is designed so as to measure the intensity “I” of the second light beam 66 on the other side of the preform 12 relative to the “X” axis of the preform 12 after it has passed through the wall 16 twice at two diametrically opposite points, at the same height “h” on the preform 12.

In this configuration, it is preferable for the second predetermined wavelength “λ2” to be selected in a wavelength range whereby the thermoplastic material is transparent enough for the intensity “I” of the second light beam 66, after it has passed through the wall 16 twice, to be measured with sufficient precision and certainty by the measurement component. Indeed, the intensity “I” of the second light beam 6 would risk being too attenuated after two passes through the wall 16 if it was emitted at a wavelength that is easily absorbed by the thermoplastic material.

For example, in the case of a plastic material made of PET or rPET, the second wavelength “λ2” is within the ranges that range between 800 nm and 1,100 nm, or between 1,250 nm and 1,300 nm. The second wavelength “λ2” is selected, for example, from among the following values: 850 nm, 860 nm, 880 nm, 940 nm, 950 nm, 960 nm, 980 nm, 1,050 nm or 1,300 nm.

In a variant of the invention, not shown, the intensity measurement component is arranged so as to measure the intensity of the second light beam after it has passed through the wall of the preform once. In this case, the measurement component comprises a component for intercepting the second light beam that is introduced into the preform during the first step, with the interception component guiding the intercepted light beam to an intensity measurement component.

The second wavelength “λ2” of the second light beam 66 in this case is outside the wavelength range “λ1” of the first light beam 55.

The measurement component in this case is formed by a spectrometer measuring the intensity “I” and the second wavelength “λ2” of the second light beam 66 after passing through at least one thickness of the wall 16 of the preform 12.

The emission light intensity “I0” at which the first light beam 55 is emitted is known data.

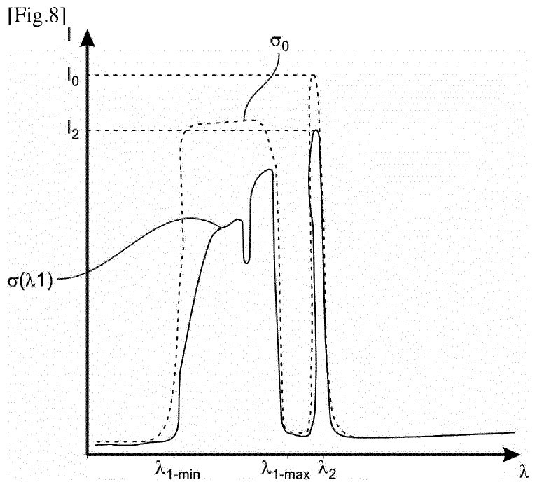

The light intensity “I0” at which the second light beam 66 is emitted also can be measured directly by the measurement component 62 when no preform 12 passes through the measurement area “Z”, as shown by the dashed lines in FIG. 8.

After passing through the wall 16 of the preform 12 twice, the light intensity of the second light beam 66 is attenuated. The second light beam 66 then has a light intensity, called “transmitted light intensity “I2”. Thus, it is easy to derive the infrared transmittance “T(λ2)” therefrom as a function of the ratio of the emission light intensity “I0” to the transmitted light intensity “I2”.

Optionally, in order to precisely compute the infrared transmittance “T(λ2)”, in this case it is possible, but not compulsory, to weight this ratio by taking into account the quantity of the second light beam 68 that is reflected for each entry into a wall 6. This reflected quantity is computed as a function of the reflectance “R”, which is a previously known quantity.

The weighting factor for the passage of the second light beam 66 through a wall thickness 16 is computed according to the following equation:

$${f}_{1} = \frac{{( 1 - R )}^{2}}{1 - {R}^{2}}$$

The weighting factor for the passage of the second light beam 66 through two wall thicknesses 16 is computed according to the following equation:

$${f}_{2} = \frac{{f}_{1}}{( 2 - {f}_{1} )}$$

The infrared transmittance “T(λ2)” when passing through two wall thicknesses 16 is thus computed by applying the following equation:

$$T ( λ 2 ) = \frac{{I}_{2}}{{I}_{0}} \cdot {f}_{2}$$

The infrared transmittance “T(λ2)” is computed by the electronic control unit 54 that receives the measurements carried out by the measurement component.

Advantageously, the measurement of the value representing the infrared transmittance “T(λ2)” and the measurement of the absorption spectrum “σ(λ1)” of the wall 16 are carried out simultaneously in the same measurement area Z of the production path 34.

To this end, the device 56 for measuring the absorption spectrum “σ(λ1)” in the visible light range and the component for measuring the infrared transmittance “T(λ2)” in this case are arranged in the common measurement area “Z”, as shown in FIG. 7.

Highly advantageously, the spectrometer of the device 56 for measuring the absorption spectrum “σ(λ1)” in the visible light range and the spectrometer of the device 64 for measuring the infrared transmittance “T(λ2)” are formed by a single spectrometer 70 common to both devices 56, 64.

To this end, the first light beam 55 and the second light beam 66 are merged into a common beam 72 before reaching the preform. This merging is carried out, for example, by means of an optical coupler 74. Thus, the spectrum of the common beam 72 has a continuous portion in the visible light range, and a peak for the value of the second wavelength “λ2”, as shown by the dashed curve in FIG. 8.

As a variant, not shown, the first light beam 55 emitted by the first light source 58 has a continuous spectrum that includes said at least one second wavelength “λ2”. In this case, the first light beam 55 alone allows both measurements to be carried out simultaneously and the second light source is not necessary. The common spectrometer 72 allows the two measurements to be simultaneously obtained from the first light beam 55 alone. Such a first light source 58 is formed, for example, by a halogen lamp.

The spectrum measured by the common spectrometer 70 after the common beam 72 has passed through the wall 16 is shown as a solid line in FIG. 8. It simultaneously shows the absorption spectrum “σ(λ1)” and the intensity peak “I2” for the second wavelength “λ2”.

The common light beam 72 is emitted perpendicular to the wall 16 of the preform 12 so as to pass through the wall 16 by passing through its main “X” axis.

The common light beam 72 is more specifically emitted along an axis perpendicular to a tangent to the path of the preform 12 in the common measurement area “Z”.

The common light beam 72 passes through the wall 16 at said height “h”.

As a variant of the invention, not shown, the device 56 for measuring the absorption spectrum “σ(λ1)” in the visible light range and the device 64 for measuring the infrared transmittance “T(λ2)” are arranged in two distinct measurement areas of the production path in such a way that the two corresponding measurements are successively carried out on the same preform. In this case, each device comprises a light source and an associated spectrometer.

The second control step “E2” comprises the first computation sub-step “E2-1” as described in the first embodiment.

This first sub-step “E2-1” uses the same computations as described in the first embodiment, but it is supplemented by taking into account the infrared transmittance “T(λ2)” measured during the fourth step “E4” for computing the corrected power “Ptc” of the heating electromagnetic radiation.

According to one embodiment, the corrected power “Ptc” is also computed during the first sub-step “E2-1” as a function of the measured infrared transmittance “T(λ2)”. The correction value is more specifically computed as a function of a transmission rate “ΔT(λ2)” that is computed according to the following equation:

$$Δ T ( λ 2 ) = \frac{{T}_{0} ( λ 2 ) - T ( λ 2 )}{{T}_{0} ( λ 2 )}$$

where “T0(λ2)” represents a reference infrared transmittance value and “T(λ2)” represents the infrared transmittance measured during the fourth step “E4”.

The reference value is, for example, of the first preform 12, called reference preform 12, at the start of production.

The reference value is, for example, the infrared transmittance “T(λ2)” that corresponds to the specifications of a preform 12, called reference preform 12. It also can be the infrared transmittance “T(λ2)” measured for a preform 12 taken as a sample from the batch of preforms 12 to be processed by the facility 10, or even the average of any infrared transmittance “T(λ2)” measured for a sample of several preforms 12 taken from the batch of preforms 12 to be processed.

The transmission rate “ΔT(λ2)” is thus likely to vary between 0, for a preform 12 with the same infrared transmittance “T(λ2)” as the reference preform 12, and 1.

The corrected power “Ptc” is also computed as a function of the proportion of the power of the heating electromagnetic radiation extending into the near infrared band. The power of the heating electromagnetic radiation is then corrected according to the following equation:

$$Ptc = Pnir 0. ( 1 - Δ T ( λ 2 ) ) + Pvis 0. ( 1 - Δ L \text{*)}$$

During the second control sub-step “E2-2” of the second step “E2”, the power of the heating electromagnetic radiation is controlled as a function of the corrected power “Ptc” computed during the first sub-step “E2-2” of heating the body 14 of the preforms 12 to the setpoint temperature by taking into account the tint of the preforms 12 and the infrared transmittance “T(λ2)” of the preforms 12 in the near infrared band.

Preferably, but not necessarily, in order to prevent the power of the heating radiation from changing too chaotically and quickly as a function of the various values measured for each preform 12, the corrected power “Ptc” is computed by taking into account the measurement of the lightness, for several successive preforms 12. The number of preforms 12 is, for example, equal to the number of preforms likely to be simultaneously contained in the heating area 42. In this case, it is a sliding average that is updated for each new preform 12 received in the measurement area “Z”.

As a variant applicable to all the previously described embodiments, the corrected power also can be computed even more precisely by taking into account the measured parameters a* and b* for each preform 12 in order to define a correction factor that is even more precisely dependent on the various wavelengths belonging to the visible light range. Such a correction would thus take into account not only the lightness of the wall 16 of the preform 12 but also its color.

1. A method for controlling a heating station of a facility for manufacturing containers by shaping preforms made of thermoplastic material by stretch-blowing, the preforms being conveyed along a production path that passes through a heating area in which the preforms are exposed to continuous spectrum heating electromagnetic radiation, said spectrum at least partly extending into a visible light range, wherein the method comprises:
a first step of measuring an absorption spectrum (σ(λ1)) of a wall of a preform in the visible light range in a measurement area traversed by the production path upstream of the heating area; and
a second step of controlling a power of the heating electromagnetic radiation as a function of the absorption spectrum (σ(λ1)) measured during the first step, wherein the second step controls] heating a body of the preforms to a setpoint temperature.

2. The method as claimed claim 1, wherein the second control step comprises a first sub-step of computing a corrected power (Ptc) of the heating electromagnetic radiation as a function of the absorption spectrum (σ(λ1)) measured during the first step, and a second sub-step of controlling the power of the heating electromagnetic radiation at said corrected power (Ptc) computed during the first sub-step.

3. The method as claimed in claim 2, wherein, during the first computation sub-step, the measured absorption spectrum (σ(λ1)) is used to compute parameters of the wall of the preform in a determined color space equivalent to a CIELAB color space as defined by ISO standard 11664-4:2019.

4. The method as claimed claim 3, wherein the corrected power (Ptc) is computed during the first sub-step at least as a function of a value of a parameter (p) representing a luminance of the wall in the determined color space.

5. The method as claimed in claim 4, wherein the corrected power (Ptc) is computed as a function of a rate of said parameter (p) that is computed according to the following equation:
$$Δ p = \frac{{p}_{0} - p}{{p}_{0}}$$
where p₀ represents a reference value of the parameter and p represents the parameter computed based on the absorption spectrum (σ(λ1)) measured during the first step.

6. The method as claimed claim 5, wherein the corrected power (Ptc) is computed as a function of a proportion of the power (Pvis) of the heating electromagnetic radiation extending into the visible light range.

7. The method as claimed in claim 1, wherein the heating radiation at least partly extends into a near infrared band and wherein the method comprises a third step of measuring an infrared transmittance (T(λ2)) of a wall of said preform for at least one wavelength (λ2) belonging to the near infrared band, the third step being carried out prior to the first computation sub-step.

8. The method as claimed in claim 7, wherein a corrected power (Ptc) is computed as a function of a transmission rate (ΔT(λ2)) that is computed according to the following equation:
$$Δ T ( λ 2 ) = \frac{{T}_{0} ( λ 2 ) - T ( λ 2 )}{{T}_{0} ( λ 2 )}$$
where T0(λ2) represents a reference infrared transmittance value and T(λ2) represents the infrared transmittance measured during the third step.

9. The method as claimed in claim 8, wherein the corrected power (Ptc) is computed as a function of a proportion of the power (Pnir) of the heating electromagnetic radiation extending into the near infrared band.

10. A facility for implementing a method of controlling a heating station of a facility for manufacturing containers by shaping preforms made of thermoplastic material by stretch-blowing, the facility comprising:
a conveyor for conveying preforms in a line along a predetermined production path successively passing through an area for heating a body of the preforms and through a station for shaping the preforms into a container by stretch-blowing,
wherein the facility comprises a device for measuring an absorption spectrum (σ(λ1)) in a visible light range of at least one wall of the preforms when the preforms pass through an associated measurement area.

11. The facility as claimed in claim 10, wherein the device for measuring the absorption spectrum (σ(λ1)) comprises:
a first light source that emits a first light beam according to a continuous spectrum (00) that at least extends into the visible range; and
a spectrometer measuring an intensity and a wavelength (λ1) of the first light beam after passing through at least one thickness of the wall of the preform.

12. The facility as claimed in claim 10, comprising a device for measuring an infrared transmittance (T(λ2)) of at least one wall of the preforms when the preforms pass through an associated measurement area.

13. The facility as claimed in claim 12, wherein the device for measuring a value representing the infrared transmittance (T(λ2)) comprises:
a light source that emits a light beam having at least one second wavelength in a near infrared band; and
a measurement component measuring an intensity for the at least one second wavelength (λ2) of said light beam after passing through at least one thickness of the wall of the preform.

14. The facility as claimed in claim 11, wherein the first light beam emitted by the first light source has a continuous spectrum that comprises said at least one second wavelength (λ2).

15. The facility as claimed in claim 13, wherein the device for measuring a value representing the infrared transmittance (T(λ2)) comprises a second light source that is distinct from the first light source and that emits a second light beam having at least one second wavelength (λ2) in the near infrared band.

16. The facility as claimed in claim 15, wherein the first light beam and the second light beam pass through the wall of the preform at a same height.

17. The facility as claimed in claim 16, wherein the first light beam and the second light beam are merged into a common beam before reaching the preform.

18. The facility as claimed in claim 13, wherein the measurement of the infrared transmittance (T(λ2) and the measurement of the absorption spectrum (σ(λ1)) are carried out simultaneously in the same measurement area of the production path.

19. The facility as claimed in claim 13, wherein the measurement component of the device for measuring the infrared transmittance (T(λ2)) and the spectrometer of the device for measuring the absorption spectrum (σ(λ1)) are formed by a single spectrometer common to the two devices; and
wherein the device for measuring the absorption spectrum (σ(λ1)) comprises:
a first light source that emits a first light beam according to a continuous spectrum (σ0) that at least extends into the visible range; and
a spectrometer measuring the intensity and the wavelength (λ1) of the first light beam after passing through at least one thickness of the wall of the preform.
